(19) United States
(12) Patent Application Publication
(10) Pub. No.: US 2015/0062287 A1
(43) Pub. Date: Mar. 5, 2015

(54) INTEGRATING VIDEO WITH PANORAMA

(71) Applicant: Google Inc., Mountain View, CA (US)

(72) Inventor: Tilman Reinhardt, Woodside, CA (US)

(73) Assignee: GOOGLE INC., Mountain View, CA (US)

(21) Appl. No.: 14/010,742

(22) Filed: Aug. 27, 2013

(51) Int. Cl. H04N 5/232

(52) U.S. Cl. CPC H04N 5/23238
USPC 348/36

(57) ABSTRACT

Aspects of the disclosure relate generally to sharing and displaying streaming videos in panoramas. As an example, a first user may record a video using a mobile computing device. This video, or the series of frames that make up the video, may be uploaded to a server along with location information. Using the location information, the server may identify a panorama. The server may also compare frames of the video to the panorama in order to select an area of the panorama. A second user may request to view the video stream. In response, the server may send the video stream and panorama to the second user's device with instructions to display the video stream overlaid on the selected area of the corresponding panorama.

### BACKGROUND

Various systems may provide users with images of different locations. Some systems provide users with panoramic images or panoramas having a generally wider field of view. For example, panoramas may include an image or collection of images having a field of view which is greater than that of the human eye, e.g., 180 degrees or greater. Some panoramas may provide a 360-degree view of a location.

### SUMMARY

One aspect of the disclosure provides a computer-implemented method. The method includes receiving, by one or more computing devices, a video stream and location information associated with the video stream; selecting, by the one or more computing devices, a panorama from a plurality of panoramas based on the location information; comparing, by the one or more computing devices, one or more frames of the video stream to the panorama; using, by the one or more computing devices, the comparison to identify an area of the panorama that corresponds to the one or more frames of the video stream; and associating, by the one or more computing devices, the video stream with the identified area.

In one example, the method also includes receiving, from a client computing device, a request for a video stream; and sending to the client computing device, the video stream, panorama, and instructions to display the video stream overlaid on the area of the panorama. In this example, instructions to share the video stream are included with the received video stream and the location information, and the method further comprises, before sending the video stream to the client computing device, determining whether the client computing device is able to access the video stream based on the instructions to share. In addition, or alternatively, this example also includes identifying a second video stream associated with a second area of the panorama, and sending, to the client computing device, the second video stream with instructions to overlay the second video stream on the second area of the panorama such that the first and second video streams are both displayed on the panorama at the same time. In this example, the method also includes receiving first data indicating a time of the video stream; receiving second data indicating a time of the second video stream; and sending, to the client computing device, the first data, the second data, and instructions to synchronize the video stream and the second video stream using the first data and the second data.

In addition, or as an alternative to the above examples, the method also includes before receiving the request for the video stream, sending a list of video streams to the client computing device and the request for the video stream identifies a video stream of the list of video streams. In this example, the method also includes sending, with the list of video streams, map information and information identifying locations for each video stream of the list of video streams.

In another example, the method includes receiving a second video stream and second location information associated with the second video stream; using the second location information to identify the panorama; comparing one or more frames of the second video stream to the one or more frames of the video stream; identifying a second area of the panorama based on the comparison; and associating the second area of the panorama with the second video stream. In another example, the method also includes retrieving 3D depth data for the panorama, and distorting the video stream so that the video stream will be displayed as if the video stream were captured at a same location as a camera that captured the panorama, using the 3D depth data for the panorama. Alternatively, the method includes retrieving 3D depth data for the panorama and distorting the panorama so that the panorama will be displayed as if the panorama were captured at a same location as a camera that captured the video stream, based at least in part on the 3D depth data for the panorama.

Another aspect of the disclosure provides a system. The system includes one or more computing devices configured to receive a video stream and location information associated with the video stream; select a panorama from a plurality of panoramas based on the location information; compare one or more frames of the video stream to the panorama; use to identify an area of the panorama that corresponds to the one or more frames of the video stream; and associate the video stream with the identified area.

In one example, the one or more computing devices are also configured to receive, from a client computing device, a request for a video stream and send to the client computing device, the video stream, panorama, and instructions to display the video stream overlaid on the area of the panorama. In this example, instructions to share the video stream are included with the received video stream and the location information, and the one or more computing devices are further configured to, before sending the video stream to the client computing device, determining whether the client computing device is able to access the video stream based on the instructions to share. In addition or as an alternative to this example, the one or more computing devices are also configured to identify a second video stream associated with a second area of the panorama and send, to the client computing device, the second video stream with instructions to overlay the second video stream on the second area of the panorama such that the first and second video streams are both displayed on the panorama at the same time. In this example, the one or more computing devices are further configured to receive first data indicating a time of the video stream; receive second data indicating a time of the second video stream; and send, to the client computing device, the first data, the second data, and instructions to synchronize the video stream and the second video stream using the first data and the second data.

In addition, or as an alternative to the above examples, the one or more computing devices are also configured to, before receiving the request for the video stream, send a list of video streams to the client computing device, and the request for the video stream identifies a video stream of the list of video streams. In this example, the one or more computing devices are also configured to send, with the list of video streams, map information and information identifying locations for each video stream of the list of video streams.

In another example, the one or more computing devices are further configured to receive a second video stream and second location information associated with the second video stream; use the second location information to identify the panorama; compare one or more frames of the second video stream to the one or more frames of the video stream; identify a second area of the panorama based on the comparison; and associate the second area of the panorama with the second video stream. In another example, the one or more computing devices are also configured to retrieve 3D depth data for the panorama and distort the video stream so that the video stream will be displayed as if the video stream were captured at a same location as a camera that captured the panorama, using the 3D depth data for the panorama. In another example, the one or more computing devices are further configured to retrieve 3D depth data for the panorama and distort the panorama so that the panorama will be displayed as if the panorama were captured at a same location as a camera that captured the video stream, based at least in part on the 3D depth data for the panorama.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is an example of a client computing device capturing a video stream in accordance with aspects of the disclosure.

FIG. 4 is an example screen shot and client computing device in accordance with aspects of the disclosure.

FIG. 5 is an example of panorama and video stream data in accordance with aspects of the disclosure.

FIG. 6 is another example of panorama data in accordance with aspects of the disclosure.

FIG. 7 is another example of panorama and video stream data in accordance with aspects of the disclosure.

FIG. 8 is an example screen shot in accordance with aspects of the disclosure.

FIG. 9 is another example screen shot in accordance with aspects of the disclosure.

FIG. 10 is a further example screen shot in accordance with aspects of the disclosure.

FIGS. 11A and 11B are each examples of a video stream and a panorama in accordance with aspects of the disclosure.

FIG. 12 is a flow diagram in accordance with aspects of the disclosure.

FIG. 13 is another flow diagram in accordance with aspects of the disclosure.

FIGS. 14A and 14B are example data in accordance with aspects of the disclosure.

### DETAILED DESCRIPTION

### Overview

Various aspects described herein allow users to share streaming videos with other users. For example some users may be interested in viewing streaming videos of various locations in real (or near real) time. Other uses may want to record and share their own videos as the video is being recorded. For example, a first user may want to share with the world the current view of fireworks from a local park. The first user could take the panorama, upload it to the appropriate system with the appropriate permissions, and then other users would be able to see, in near real time, the view of the fireworks.

The aspects described below allow users to share visual experiences as they are occurring. In this regard, a user at one location may share a video stream of what is occurring at that user's location with a number of different users at once. In addition, the video streams may be displayed relative to an image or three dimensional model (3D) of the location where the video stream was (or is being) captured, such that users may also be able to view the video stream with regard to its geographic context.

As an example, a first user may record a video using a mobile computing device, such as a phone or other recording device, by capturing a series of frames of a scene. The frames that make up the video may then be uploaded (e.g. at the request of the first user) to a server computing device as soon as available processing resources, network resources and other resources permit. In addition to the video, the mobile computing device may send, and the server computer may receive, location information for the mobile computing device capturing the video.

The server computing device may have access to a plurality of panoramic images. Using the location information, the server computing device may identify a panoramic image proximate to the location of the mobile computing device. The server computing device may also compare one or more of the frames of the video to the identified panorama in order to select an area of the identified panorama that corresponds to the video.

The video may then be associated with the area of the identified panorama. In this way, when the same or another user having a computing device requests to view the panorama and/or the video, the other user is able to view the streaming video overlaid on the associated area of the panorama. For example, a second user may be provided with two or more video streams displayed relative to a map and, when the second user selects one of the video streams, the server computing device may select or identify the corresponding panorama and display the video stream overlaid on the associated area of the corresponding panorama. Thus, the second user may view, on his or her computing device in near real time, what is happening at the location of the first user.

The features described herein may also allow the second user to experience multiple videos in the same panorama. In one example, frames from a second video may also be matched to the panorama if both videos were captured at or near the same location. In addition to matching frames of the video to the panorama, the server computing device may also match frames of that video to a second video and overlay both videos on the panorama. In some examples, if the server computing device receives orientation information, this orientation information may be used to determine the area of the panorama that should correspond to the video. This orientation information can be used instead of or in conjunction with the comparing of frames to the panorama as described above.

The video stream may be captured from a different viewpoint than the panorama, e.g., the video stream and the panorama may be captured from different locations. If so, using three-dimensional (3D) depth data for the panorama, the video stream may be displayed as if it was captured at the same location as the panorama was captured so that the video stream is not distorted. Alternatively, the video stream may be overlaid onto the panorama and distorted so that the video appears as if it were playing where it would be if the user were standing at the center of the panorama. In another example, the panorama may be distorted so that the center of the panorama matches the location information associated with the video stream.

### Example Systems

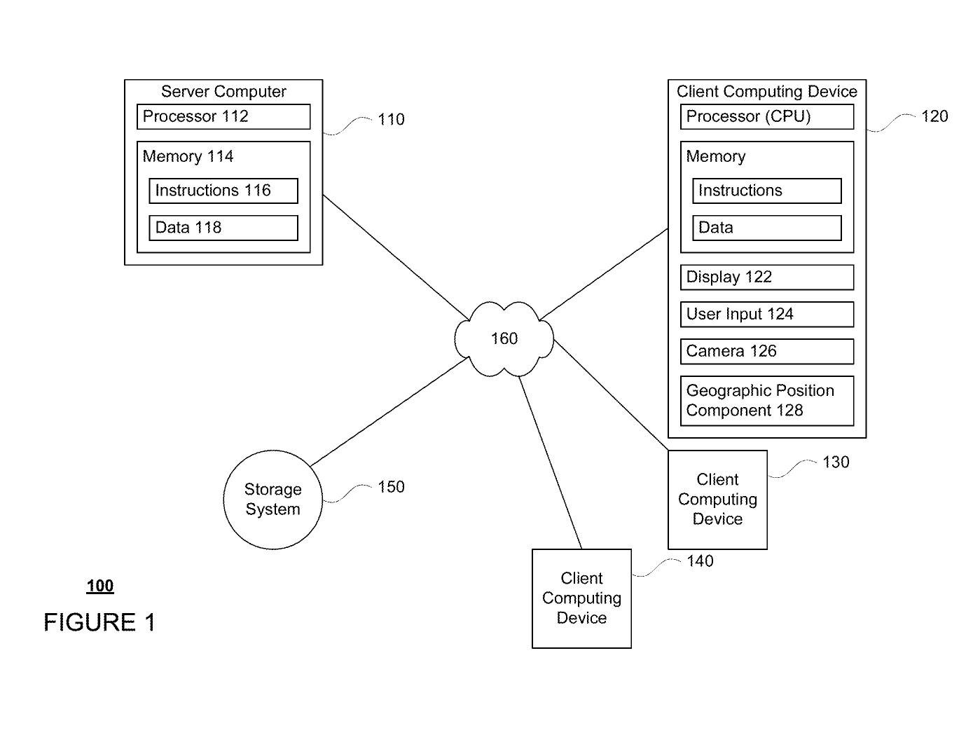

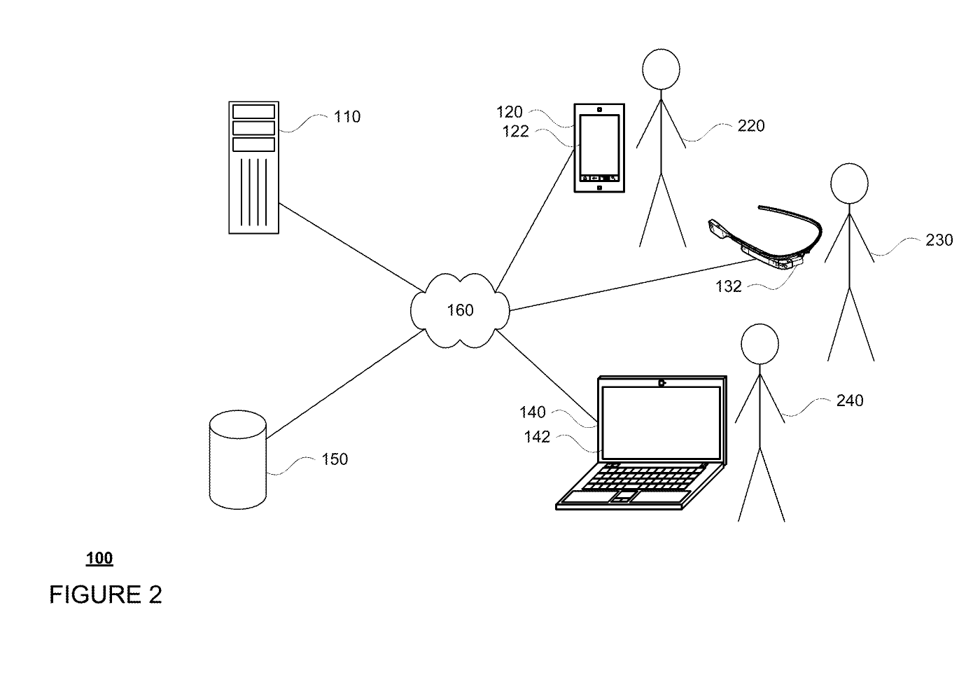

FIGS. 1 and 2 include an example system 100 in which the features described above may be implemented. It should not be considered as limiting the scope of the disclosure or usefulness of the features described herein. In this example, system 100 can include computing devices 110, 120, 130, and 140 as well as storage system 150. Computing device 110 can contain a processor 112, memory 114 and other components typically present in general purpose computing devices. Memory 114 of computing device 110 can store information accessible by processor 112, including instructions 116 that can be executed by the processor 112.

Memory can also include data 118 that can be retrieved, manipulated or stored by the processor. The memory can be of any type capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the processor. In that regard, the terms “instructions,” “application,” “steps” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

Data 118 can be retrieved, stored or modified by processor 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The processor 112 can be any conventional processor, such as a commercially available CPU. Alternatively, the processor can be a dedicated component such as an ASIC or other hardware-based processor. Although not necessary, computing device 110 may include specialized hardware components to perform specific computing processes, such as decoding video, matching video frames with images, distorting videos, encoding distorted videos, etc. faster or more efficiently.

Although FIG. 1 functionally illustrates the processor, memory, and other elements of computing device 110 as being within the same block, the processor, computer, computing device, or memory can actually comprise multiple processors, computers, computing devices, or memories that may or may not be stored within the same physical housing. For example, the memory can be a hard drive or other storage media located in a housing different from that of computing device 110. Accordingly, references to a processor, computer, computing device, or memory will be understood to include references to a collection of processors, computers, computing devices, or memories that may or may not operate in parallel. For example, the computing device 110 may include a single server computing device or a load-balanced server farm. Yet further, although some functions described below are indicated as taking place on a single computing device having a single processor, various aspects of the subject matter described herein can be implemented by a plurality of computing devices, for example, communicating information over network 160.

The computing device 110 can be at one node of a network 160 and capable of directly and indirectly communicating with other nodes of network 160. Although only a few computing devices are depicted in FIGS. 1-2, it should be appreciated that a typical system can include a large number of connected computing devices, with each different computing device being at a different node of the network 160. The network 160 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, computing device 110 may include a web server that is capable of communicating with storage system 150 as well as computing devices 120, 130, and 140 via the network. For example, server 110 may use network 160 to transmit and present information to a user, such as user 210, 220, or 230, on a display, such as displays 122, 132, or 142 of computing devices 120, 130, or 140. In this regard, computing devices 120, 130, and 140 may be considered client computing devices and may perform all or some of the features described below with regard to FIGS. 2 and 8-11.

Each of the client computing devices may be configured similarly to the server 110, with a processor, memory and instructions as described above. Each client computing device 120, 130 or 140 may be a personal computing device intended for use by a user 220, 230, 240, and have all of the components normally used in connection with a personal computing device such as a central processing unit (CPU), memory (e.g., RAM and internal hard drives) storing data and instructions, a display such as displays 122, 132, or 142 (e.g., a monitor having a screen, a touch-screen, a projector, a television, or other device that is operable to display information), and user input device 124 (e.g., a mouse, keyboard, touch-screen or microphone). The client computing device may also include a camera 126 for recording video streams, speakers, a network interface device, and all of the components used for connecting these elements to one another.

Although the client computing devices 120, 130 and 140 may each comprise a full-sized personal computing device, they may alternatively comprise mobile computing devices capable of wirelessly exchanging data with a server over a network such as the Internet. By way of example only, client computing device 120 may be a mobile phone or a device such as a wireless-enabled PDA, a tablet PC, or a netbook that is capable of obtaining information via the Internet. In another example, client computing device 130 may be a head-mounted computing system. As an example the user may input information using a small keyboard, a keypad, microphone, using visual signals with a camera, or a touch screen.

Client computing devices 120 and 130 may also include a geographic position component 128 in communication with the client computing device's processor for determining the geographic location of the device. For example, the position component may include a GPS receiver to determine the device's latitude, longitude and/or altitude position. The client computing device's location may also be determined using cellular tower triangulation, IP address lookup, and/or other techniques.

The client computing devices may also include other devices such as an accelerometer, gyroscope, compass or another orientation detection device to determine the orientation of the client computing device. By way of example only, an acceleration device may determine the client computing device's pitch, yaw or roll (or changes thereto) relative to the direction of gravity or a plane perpendicular thereto. The client computing devices' provision of location and orientation data as set forth herein may be provided automatically to the users 220, 230, or 140, computing device 110, as well as other computing devices via network 160.

Storage system 150 may store map data, video streams, and or panoramas such as those discussed above. As with memory 114, storage system 150 can be of any type of computerized storage capable of storing information accessible by server 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to the computing devices via the network 160 as shown in FIG. 1 and/or may be directly connected to any of the computing devices 110-140 (not shown).

The panoramas may be retrieved or collected from various sources. A panorama may be collected from any suitable source that has granted the system (or the general public) rights to access and use the image. The panoramas may be associated with location information and pose information defining an orientation of the panorama.

In addition, each of the panoramas may further be associated with pre-computed depth information. For example, using location coordinates, such as latitude and longitude coordinates, of the camera that captured two or more panoramas as well as intrinsic camera settings such as zoom and focal length for the panoramas, a computing device may determine the actual geographic location of the points or pixels in the panoramas.

This 3D depth information may also be used to generate 3D models of the objects depicted in the panoramas. In addition or as an alternative to the 3D depth data and panoramas, the 3D models may be generated using other information such as laser range data, aerial imagery, as well as existing survey data.

### Example Methods

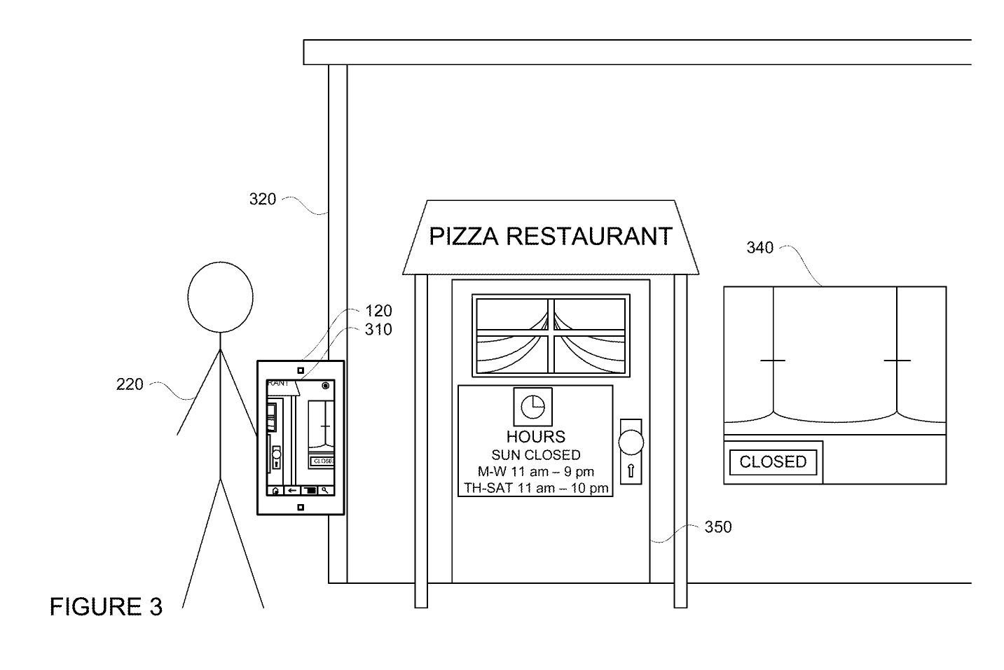

As noted above, a first user may record a video using a mobile computing device. This video may include a stream of video frames which capture images of the user's environment. For example, as shown in FIG. 3, user 220 records a video 310 on mobile phone 120 having a video camera function. In this example, the video 310 includes a portion of a building 320 of a restaurant. In this example, the video includes portions of window 340 and door 350 of building 320.

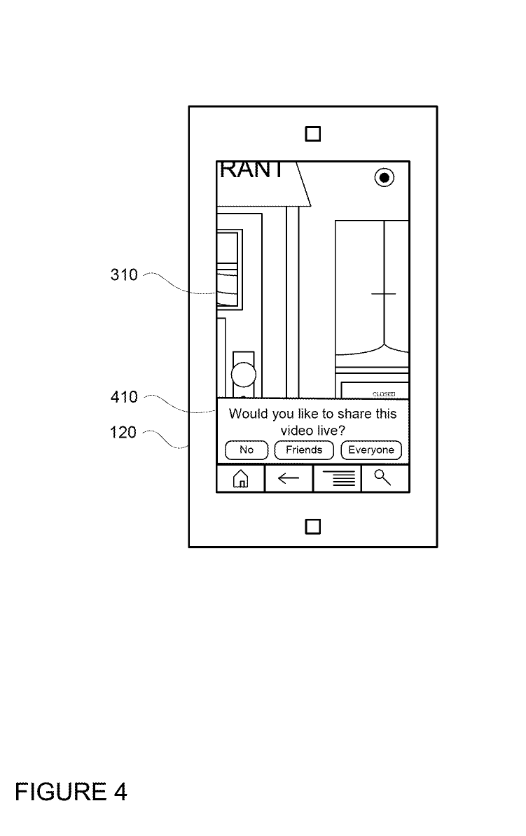

Before or while recording the video stream, the user may be provided with an option to share the video. For example, FIG. 4 is an example display for mobile phone 120. The display includes a prompt 410 indicating that the user is recording a video and asking if the user would like to share the video stream with others. In this example, the user is able to share the video stream with particular persons which may be predetermined by the user, or “friends”. The user may also be able to share the video with “everyone”, or to make the video publically available. Alternatively, the user may decide to share the video before recording. In such an example, the prompt may be displayed before the user begins recording.

If the user has decided to share the video stream, the mobile computing device may transmit the video stream to a server computing device. The video stream may be sent to the server computing device with instructions on how to share the video stream, for example, with everyone or only with particular users. As the user is recording the video stream, the frames may be sent chronologically to the server. From a user's perspective, the server may receive the video frames as soon as, or almost as soon as, the frames are being recorded.

In addition to transmitting the frames of the video stream as well as information such as the time of the recording and sound data, to the server computing device, the mobile computing device may also send location information. This location information may be generated by a geographic position component. For example, the geographic position component of mobile phone 120 may generate location information, such as latitude-longitude coordinates or other position coordinates and send these to the processor of the mobile phone. The processor, in turn, may receive the location information and forward it to the server 110. Alternatively, the location information may include an IP address or cellular tower information which the server may use to approximate the location of the mobile computing device.

As noted above, the server computing device may receive the video frames of the video stream as well as the location information. In response, the server computing device may access a plurality of panoramic images and retrieve a relevant panorama based on the location information. For example, the server 110 may retrieve the available panoramic image whose associated location is the closest, relative to other available panoramic images, to the location received from the mobile phone.

Once a panorama has been retrieved, the server computing device may compare one or more of the received video frames to the panorama. The compared data may include pixel information from both one or more video frames and the panorama. As an example, the comparison may include looking for features that match the shape and position with other similar features as well as considering differences or similarities in color histogram data, texture data, and/or geometric features or shapes such as rectangles, circles, or polygons determined by edge detection or other conventional image analysis methods. Not all features of the one or more video frames and the panorama will necessarily match. However, non-matching features may also be used as a signal to identify the relevant area of the panorama.

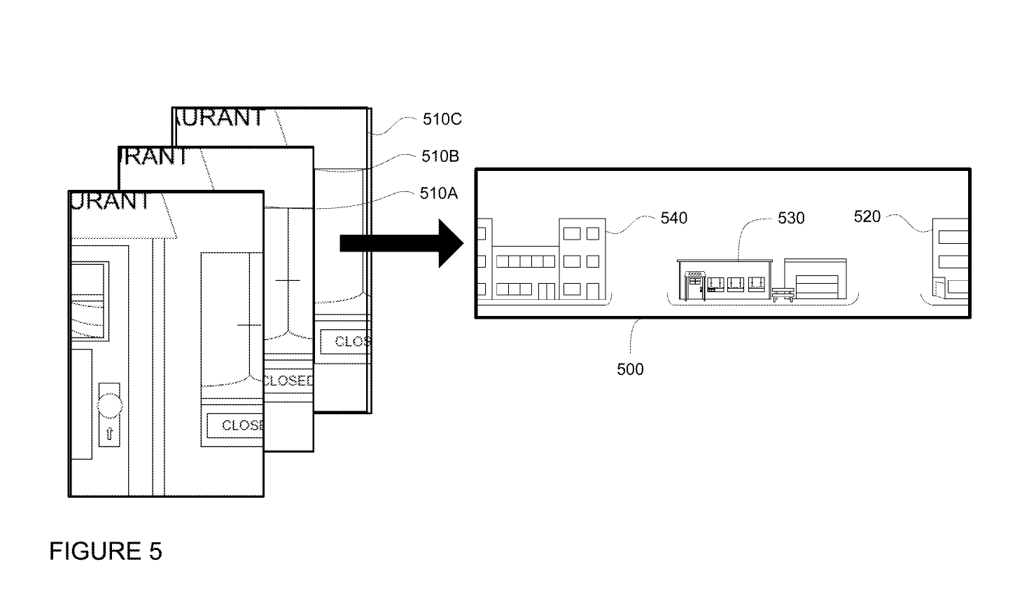

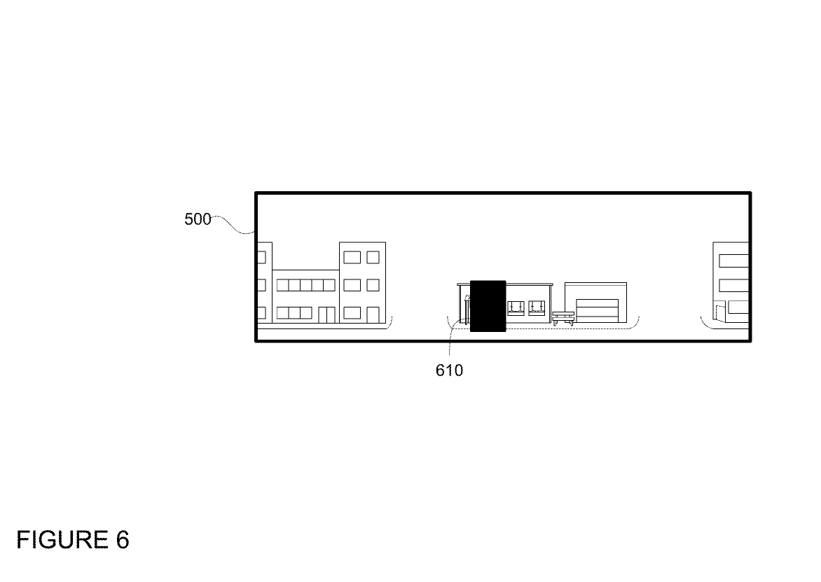

Using this comparison, the server computing device may select an area of the identified panorama that corresponds to the video. For example, as shown in FIG. 5, the server 110 may use various image matching techniques to identify similarities between the visual features of the one or more video frames 510A-C and objects 520, 530, and 540 of the identified panorama 500. FIG. 6 demonstrates the selected “area” 610 of the identified panorama 500 that corresponds to the video frames 510A-C.

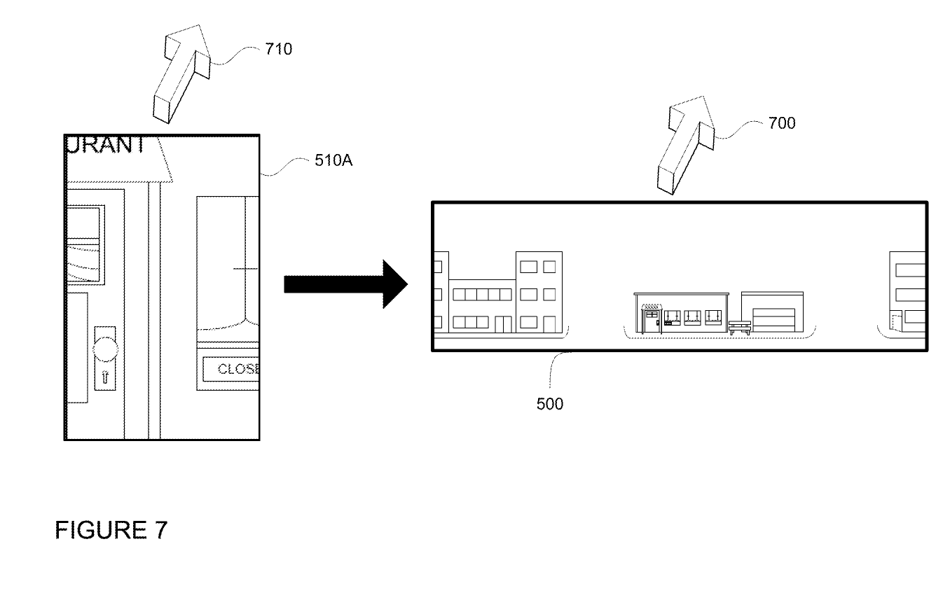

In some examples, if the server computing device receives orientation information, this orientation information may be used to determine the area of the panorama that is likely to correspond to the video. As shown in FIG. 7, if the orientation 710 of the video camera of the mobile phone 120 is also received from the mobile phone, the server 110 may align this orientation with orientation information of the identified panorama. The server may then select an area 610 of the panorama as shown in FIG. 6. This orientation information may be used instead of or in conjunction with the comparing of frames to the panorama as described above.

The server computing device may associate the area of the identified panorama with the received video frames. The association and video frames, as well as any other video information such as time and sound data, may be stored in storage system 150 in order to provide the video stream to users. For example, the association allows the server computing device to retrieve the video frame and identify the area with information identifying the panorama. Similarly, the server computing device may retrieve the panorama and area with information identifying the video stream. The server computing device may also store information identifying other users with which the first user has shared the video stream. For example, the server may store information indicating that the video stream is available to everyone or only particular users. In some examples, in order to keep the video streams as current as possible, the video streams may be associated with a time limit, such that when the time limit has passed, the video streams are no longer available to users and may be removed from the storage system.

If the first user has selected to share the video stream, before storing the video frames and/or providing them to users, the server computing device may remove personal information that may have been provided by the mobile computing device. The server computing device as well as the client device may also process the video to protect the privacy of those featured in the video such as by blurring faces, logos, writing, etc. Similarly, the server computing device may flag videos which may include objectionable subject matter for particular persons or age groups for review by an administrator before the video is made available to users.

A second user, having a second computing device may request to view a panorama and/or the video stream. In one example, the second user may view a map which identifies locations having available panorama and/or video streams. Whether a video stream is available to a particular user may be determined based on how the first user decided to share that video stream.

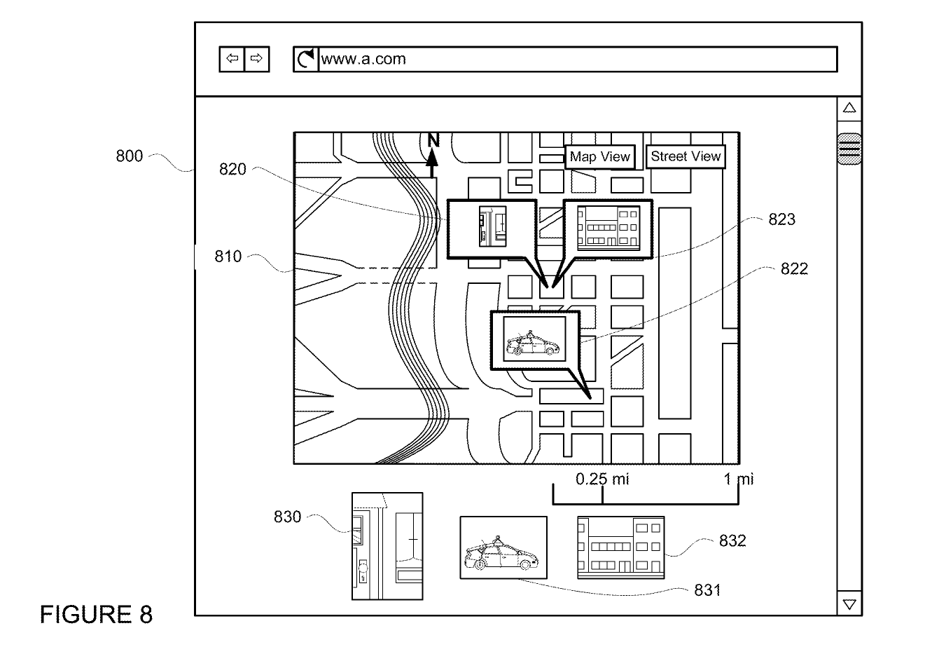

As an example, the second user may be provided with two or more available video streams displayed relative to a map. FIG. 8 is an example screen shot 800 that includes a map 810. In this example, available video streams are shown in different ways: video stream bubbles 820-822 show available video streams in relation to map 810. Video stream windows 830-832 depict a visual list of video streams below map 810. Rather than being static images, the video stream bubbles and windows may play their associated video stream, or portions thereof, within the respective bubble and window. When the second user selects one of the video stream windows or video stream bubbles, by using one of the user input devices, the second computing device may send a request for that video stream to the server computing device.

As an alternative, if the user requests to see a panorama of a particular location, for example by selecting that location, the second computing device may send a request for a panorama of that location to the server computing device. In response to receiving the request, the server computing device may retrieve both a panorama and a video stream based on their association with one another. In one example, if the second user selects a particular video stream, the server computing device may identify the associated panorama. Alternatively, if the second user selects a particular panorama, the server computing device may determine whether the panorama is associated with a video stream and, if so, the server computing device may identify the associated video stream.

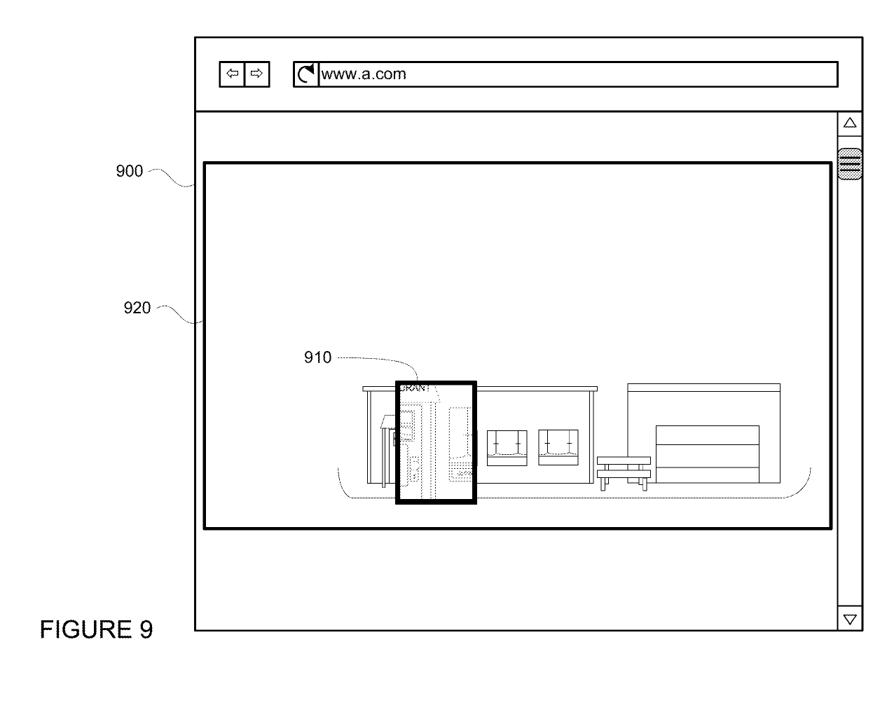

The server computing device may then transmit the video stream and panorama to the second computing device as well as instructions to display the video stream overlaid on the associated area of the panorama. FIG. 9 is an example screen shot 900 including a video stream 910 (for example, the same video stream 310 of FIG. 3) overlaid onto a panorama view 920 (which may represent a portion of panorama 500 of FIG. 5). In this example, video stream 910 plays within the panorama as it is being streamed to the second user. Thus, the second user is able to experience, on his or her computing device, what is happening at the location of the first user in near real time.

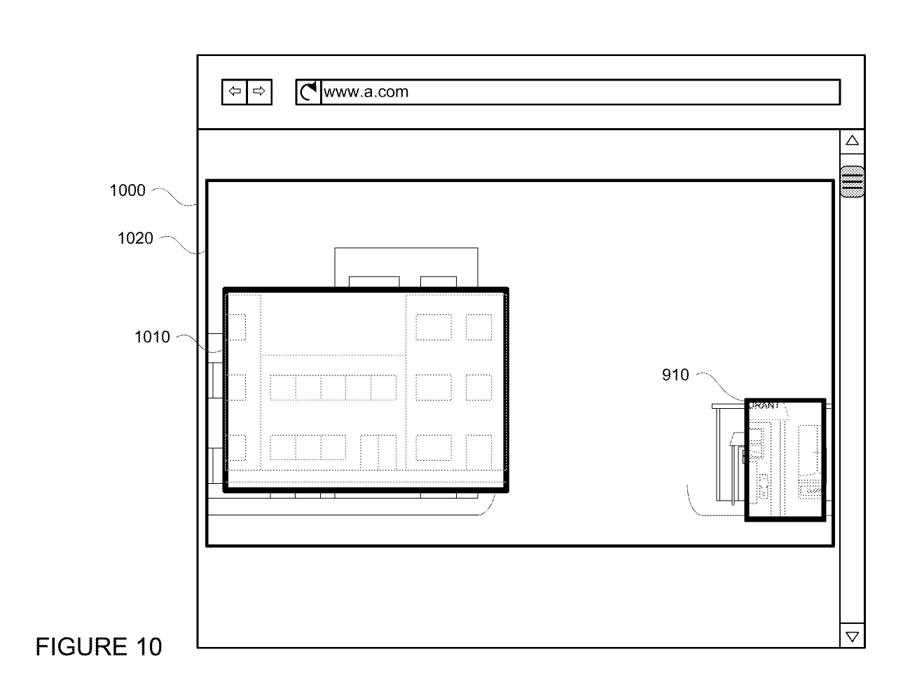

The second user may also be able to view multiple video streams in a single panorama. For example, as shown in the example screen shot 1000 of FIG. 10, video streams 910 and 1010 are overlaid onto and played within panorama 1020 for display to the second user. In one example, both a first video stream and a second video stream may be captured at or near the same location. The server may receive frames from each video stream and identify relevant areas of the same panorama for each video stream. In addition to matching frames of both the first and second video streams to the panorama, the server may match frames of that second video to frames of the first video in order to determine the relevant area of the panorama. In this regard, when a user requests to view the panorama or either the first or second video streams, the server may provide the panorama, the video streams, as well as instructions to overlay both video streams on the panorama at the corresponding areas.

In some examples, where multiple video streams are projected into the same panorama on the display of a single client computing device, the video streams may be synchronized to the same time. For example, using time stamp data associated with two different video streams, rather than starting the video streams together, one or the other may be delayed to give the user the impression that everything is occurring at the same time. This may be especially useful for displaying sporting event or fireworks shows where there may be multiple video streams. In addition, when synchronization is used to display multiple video streams at once, the synchronization may occur at the client computing device in order to better synchronize any sound from the video streams.

If the overlay of the video stream is offset from the actual orientation area of the panorama because the video stream and the panorama were not captured from the same location, the video may be displayed as if it were captured at the same location as the panorama so that the video is not distorted.

Alternatively, the panorama or the video stream may be displayed as distorted in order to display them to the user. The distorted video streams may be generated using the 3D depth data for the panorama. In addition, the distortion may be performed by the server computing device, such that the distorted video is sent to the client computing device, or the distortion may be performed by the client computing device such that the server computing device sends the undistorted video and panorama to the client computing device.

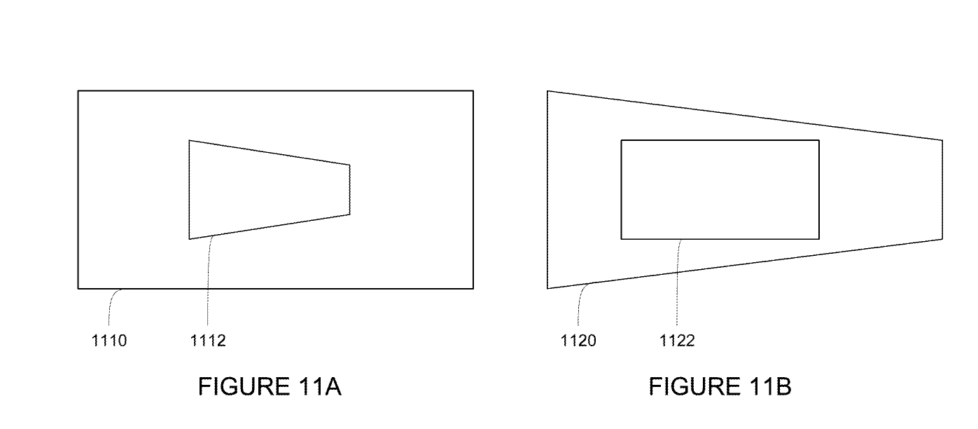

For example, as shown in the example of FIG. 11A, a video stream 1112 may be overlaid onto the panorama and distorted so that the video stream appears as if it were playing where it would be if the user were standing at the location where panorama 1110 was captured. In another example, shown in FIG. 11B a panorama 1120 may be distorted so that the location where the panorama was captured appears to matches the location information associated with the video stream 1122. Although these examples depict distorted rectangles, when the 3D depth information is used, the actual shape of the video stream or the panorama may become even more irregular.

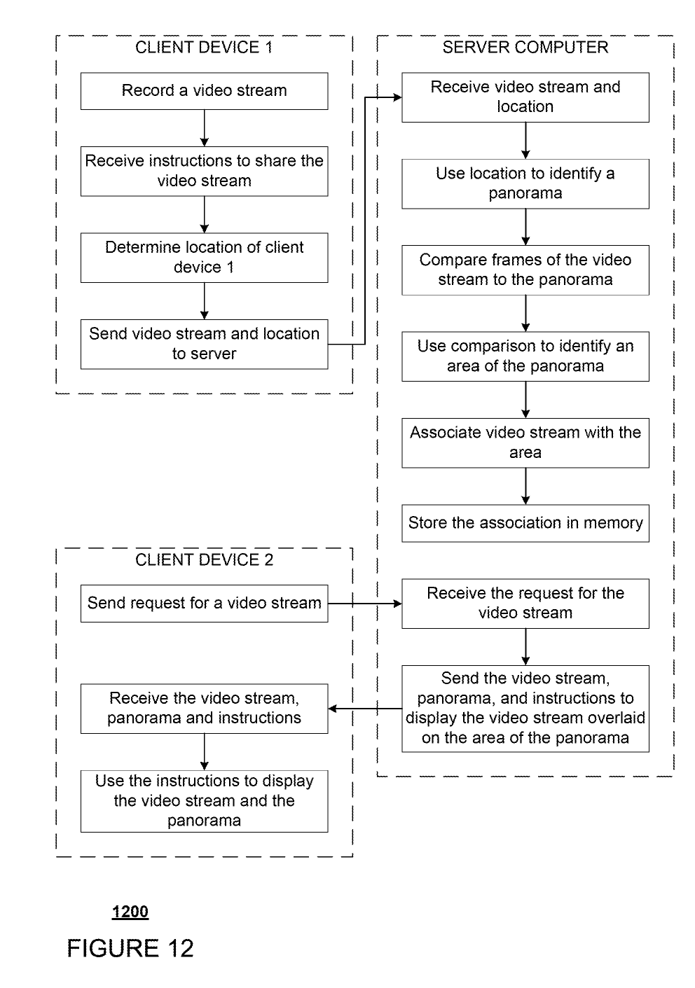

FIG. 12 is an example flow diagram 1200. Aspects of this flow diagram may be performed by various computing devices as described above. In this example, client computing device 1 records a video stream, receives instructions to share the video stream, determines the location of the client computing device 1, and sends the video stream and location to a server computing device. The server computing device, which may include one or more server computing devices, receives the video stream, uses the location to identify a panorama, compares frames of the video stream to the panorama, uses the comparison to identify an area of the panorama that corresponds to the video stream, associates the area with the video stream, and stores the association in memory.

Client computing device 2, which may be the same or different from client computing device 1, sends a request for the video stream to the server computing device. The server computing device receives the request and sends the video stream, the panorama, and instructions to display the video stream overlaid on the area of the panorama to the client computing device 2. Client computing device 2 receives the video stream, the panorama, and the instructions, and client computing device 2 uses the instructions to display the video stream and the panorama.

In addition to displaying video streams overlaid on a panorama, once an area of a panorama has been identified, this area may be used to identify a corresponding 3D model.

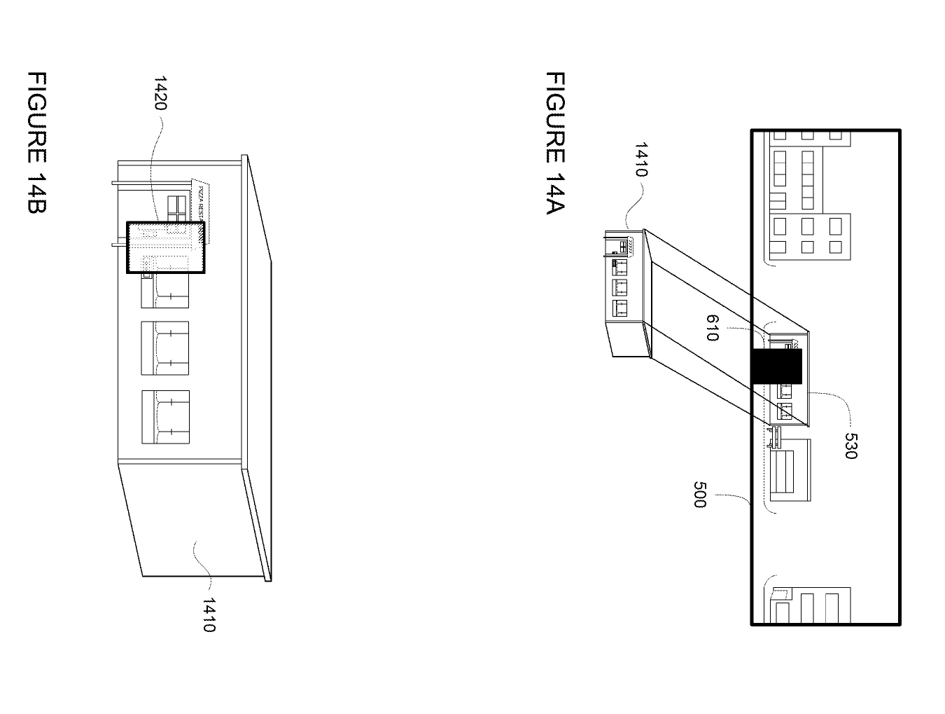

For example, as shown in FIG. 14A, building 530 of panorama 500 may be associated with a 3D model of building 530, or model 1410. As in the example described above, area 610 of FIG. 6 corresponds to a portion of building 530. Thus, video stream 1420 may be overlaid on to the portion of 3D model 1410 that corresponds to area 610 as shown in FIG. 14B. Thus, the video stream may be displayed on the client computing device as if it were simply in front or, using the 3D depth data, distorted and projected onto the 3D model 1410. Although not shown, rather than a single 3D model, the display may also include other 3D models of objects, for example within a geographic area of a 3D world visible on the client computing device.

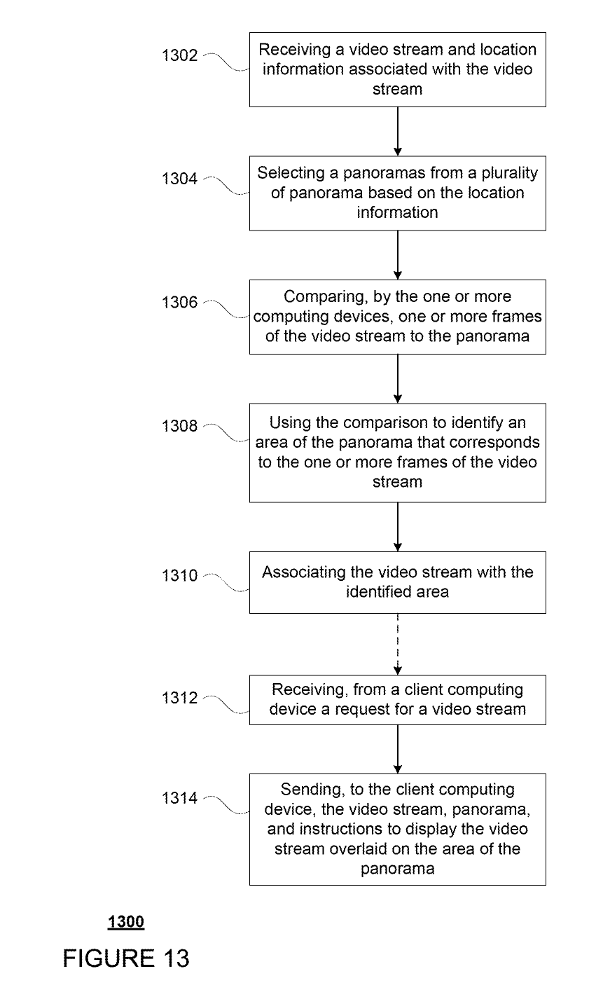

Flow diagram 1300 of FIG. 13 is another example of some of the aspects described above. The blocks of flow diagram 1300 may, for example, be performed by one or more computing devices, such as server 110 or a plurality of servers configured similarly to server 110. In this example, the one or more computing devices receives a video stream an location information associated with the video stream at block 1302. This video stream may be recorded by a first user and sent to the one or more computing devices in order to share the video stream with other users in real (or near real) time. The one or more computing devices select a panorama from a plurality of panoramas based on the location information at block 1304. For example, the one or more computing devices may retrieve the panorama from a storage system, such as storage system 150. Each of the plurality of panoramas may be associated with geographic location information. In this regard, the one or more computing devices may select the panorama that is associated with geographic location information that matches, corresponds to, or is closest to the location information associated with the video stream.

The one or more computing devices compares one or more frames of the video stream to the selected panorama at block 1306, for example, using various image matching techniques as described above. The one or more computing devices use this comparison to identify an area of the panorama that corresponds to the one or more frames of the video stream at block 1308. The video stream is then associated with the identified area at block 1310.

This association and the video stream may be stored in order to enable to provide the video stream to other users. Thus, in some example, the one or more computing devices receive from a computing device, a request for a video stream as shown in block 1312. The one or more computing devices then retrieve the video stream and the panorama. The video stream, panorama, and instructions to display the video stream overlaid on the area of the panorama are set to the client computing device by the one or more computing devices.

The aspects described above relate to using panoramas to determine where or how a video stream is displayed to a user. However, non-panoramic images such as geo referenced photographs or images contributed by users may be used to determine a particular area for displaying a video stream. This area may then be used to overlay an image onto a 3D model corresponding to the location of the area or a video stream may be displayed to a user overlaid on the non-panoramic image.

In situations in which the systems discussed here collect personal information about users, or may make use of personal information, the users may be provided with an opportunity to control whether programs or features collect user information (e.g., information about a user's social network, social actions or activities, profession, a user's preferences, the availability of the user's uploaded panoramas, and/or a user's current location), or to control whether and/or how user information is used by the system. In addition, certain data may be treated in one or more ways before it is stored or used, so that personally identifiable information is removed. For example, a user's identity may be treated so that no personally identifiable information can be determined for the user, or a user's geographic location may be generalized (such as to a city, ZIP code, or state level) so that a particular location of a user cannot be determined. Thus, the user may have control over how and what information is collected about the user and used by computing devices 100, 120, 140, or 140.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A computer-implemented method comprising:
receiving, by one or more computing devices, a video stream and location information associated with the video stream;
selecting, by the one or more computing devices, a panoramas from a plurality of panorama based on the location information;
comparing, by the one or more computing devices, one or more frames of the video stream to the panorama;
using, by the one or more computing devices, the comparison to identify an area of the panorama that corresponds to the one or more frames of the video stream; and
associating, by the one or more computing devices, the video stream with the identified area.

2. The method of claim 1, further comprising:
receiving, from a client computing device, a request for a video stream; and
sending to the client computing device, the video stream, panorama, and instructions to display the video stream overlaid on the area of the panorama.

3. The method of claim 2, wherein instructions to share the video stream are included with the received video stream and the location information, and the method further comprises, before sending the video stream to the client computing device, determining whether the client computing device is able to access the video stream based on the instructions to share.

4. The method of claim 2, further comprising:
identifying a second video stream associated with a second area of the panorama; and
sending, to the client computing device, the second video stream with instructions to overlay the second video stream on the second area of the panorama such that the first and second video streams are both displayed on the panorama at the same time.

5. The method of claim 4, further comprising:
receiving first data indicating a time of the video stream;
receiving second data indicating a time of the second video stream; and
sending, to the client computing device, the first data, the second data, and instructions to synchronize the video stream and the second video stream using the first data and the second data.

6. The method of claim 2, further comprising:
before receiving the request for the video stream, sending a list of video streams to the client computing device; and
wherein the request for the video stream identifies a video stream of the list of video streams.

7. The method of claim 6, further comprising sending, with the list of video streams, map information and information identifying locations for each video stream of the list of video streams.

8. The method of claim 1, further comprising:
receiving a second video stream and second location information associated with the second video stream; using the second location information to identify the panorama;
comparing one or more frames of the second video stream to the one or more frames of the video stream;
identifying a second area of the panorama based on the comparison; and
associating the second area of the panorama with the second video stream.

9. The method of claim 1, further comprising:
retrieving 3D depth data for the panorama; and
distorting the video stream so that the video stream will be displayed as if the video stream were captured at a same location as a camera that captured the panorama, using the 3D depth data for the panorama.

10. The method of claim 1, further comprising:
retrieving 3D depth data for the panorama; and
distorting the panorama so that the panorama will be displayed as if the panorama were captured at a same location as a camera that captured the video stream, based at least in part on the 3D depth data for the panorama.

11. A system comprising:
one or more computing devices configured to:
receive a video stream and location information associated with the video stream;
select a panorama from a plurality of panoramas based on the location information;
compare one or more frames of the video stream to the panorama;
use to identify an area of the panorama that corresponds to the one or more frames of the video stream; and
associate the video stream with the identified area.

12. The system of claim 11 wherein the one or more computing devices are configured to:
receive, from a client computing device, a request for a video stream; and
send to the client computing device, the video stream, panorama, and instructions to display the video stream overlaid on the area of the panorama.

13. The system of claim 12, wherein instructions to share the video stream are included with the received video stream and the location information, and the one or more computing devices are further configured to, before sending the video stream to the client computing device, determining whether the client computing device is able to access the video stream based on the instructions to share.

14. The system of claim 12, wherein the one or more computing devices are further configured to:
identify a second video stream associated with a second area of the panorama; and
send, to the client computing device, the second video stream with instructions to overlay the second video stream on the second area of the panorama such that the first and second video streams are both displayed on the panorama at the same time.

15. The system of claim 14, wherein the one or more computing devices are further configured to:
receive first data indicating a time of the video stream;
receive second data indicating a time of the second video stream; and
send, to the client computing device, the first data, the second data, and instructions to synchronize the video stream and the second video stream using the first data and the second data.

16. The system of claim 12, wherein the one or more computing devices are further configured to:
before receiving the request for the video stream, send a list of video streams to the client computing device; and
wherein the request for the video stream identifies a video stream of the list of video streams.

17. The system of claim 16, wherein the one or more computing devices are further configured to send, with the list of video streams, map information and information identifying locations for each video stream of the list of video streams.

18. The system of claim 11, wherein the one or more computing devices are further configured to:
receive a second video stream and second location information associated with the second video stream;
use the second location information to identify the panorama;
compare one or more frames of the second video stream to the one or more frames of the video stream;
identify a second area of the panorama based on the comparison; and
associate the second area of the panorama with the second video stream.

19. The system of claim 11, wherein the one or more computing devices are further configured to:
retrieve 3D depth data for the panorama; and
distort the video stream so that the video stream will be displayed as if the video stream were captured at a same location as a camera that captured the panorama, using the 3D depth data for the panorama.

20. The system of claim 11, wherein the one or more computing devices are further configured to:
retrieve 3D depth data for the panorama; and
distort the panorama so that the panorama will be displayed as if the panorama were captured at a same location as a camera that captured the video stream, based at least in part on the 3D depth data for the panorama.
